(19) United States
(12) Patent Application Publication
(10) Pub. No.: US 2026/0361675 A1
(43) Pub. Date: Nov. 12, 2026

(54) LINKED TRANSACTION EMAILS FOR USER VISIBILITY AND FRAUD DETECTION

(71) Applicant: Cisco Technology, Inc., San Jose, CA (US)

(72) Inventors: Suresh Gopathy, Alpharetta, GA (US); Gajendar Pandey, Bengaluru, Karnataka (IN)

(21) Appl. No.: 19/201,122

(22) Filed: May 7, 2025

(51) Int. Cl. H04L 51/42

(52) U.S. Cl. CPC H04L 51/42

(57) ABSTRACT

This disclosure describes techniques for an email system to link emails related to the same transaction. An email processing system may receive an incoming email that is to be delivered to a user of an email service. The incoming email may be associated with a transaction and sent by a particular entity. The incoming email may be sent independent of other emails (e.g., previously-received emails from different entities). The email processing system may extract information such as a unique identifier and transactional metadata from the incoming email. The email processing system may then match the transaction of the incoming email to one or more transactions of previously-received emails based on the unique identifier and/or transactional metadata, and in turn, link the incoming email to a previously-received email. The incoming email may be delivered such that the incoming email is consolidated with the previously-received email.

### TECHNICAL FIELD

The present disclosure relates generally to techniques for an email system to link emails related to the same transaction and detect fraud.

### BACKGROUND

Electronic mail, or “email,” continues to be a primary method of exchanging messages between users of electronic devices. Many messaging service providers have emerged that provide users with a variety of email platforms to facilitate the communication of emails via email servers that accept, forward, deliver, and store messages for the users. Email continues to be an important and fundamental method of communications between users of electronic devices as email provides users with a cheap, fast, accessible, efficient, and effective way to transmit all kinds of electronic data. Email is well established as a means of day-to-day, private communication for business communications, marketing communications, social communications, educational communications, and many other types of communications.

Due to the widespread use and necessity of email, entities use email as a primary channel for delivering receipts, transaction confirmations, shipping details, and/or the like to users. Messaging service providers may present more than one email as an email thread, which may group emails together chronologically. However, these email threads are grouped based on subsequent emails being responsive to (e.g., replying, forwarding, etc.) an original email. In some instances, emails related to the same transaction (e.g., an e-commerce transaction) may be sent by different entities (e.g., merchants, payment processors, shipping carriers, etc.) such that transaction-related emails may be siloed from one another because they are not responsive to an original email. In such instances, transaction-related emails may be scattered through a user's inbox, and critical information or actions may be overlooked.

Additionally, hackers and other malicious entities may use email for delivering different types of attacks. For example, malicious emails and/or electronic messages may include an indication of a fraudulent transaction (e.g., invoice fraud). Email security platforms are provided by messaging service providers (and/or third-party security service providers) that attempt to identify and eliminate attacks on email communication channels. For instance, cloud messaging services provide secure email gateways (SEGs) and/or Secure Mailboxes (SMBs) that monitor emails for malicious content and implement pre-delivery protection by blocking email-based threats before they reach a mail server. These SEGs and SMBs can scan incoming, outgoing, and internal communications for signs of malicious or harmful content. However, the siloed nature of emails from different entities, but pertaining to the same transaction, may make it difficult for the SEGs and SMBs to detect transaction fraud, particularly when a user engages in a large number of transactions.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example environment in which an email processing system determines whether an incoming email is related to the same transaction as one or more other emails, and linking the emails accordingly.

FIG. 2 illustrates a diagram of components of an email processing system.

FIG. 3 illustrates an example environment in which the email processing system determines whether the transaction of an email corresponds to the transaction of another email based on transactional metadata.

FIG. 4 illustrates a flow diagram of an example process of transaction matching for incoming emails.

FIG. 5 illustrates a flow diagram of an example process for linking emails related to the same transaction.

FIG. 6 illustrates a computing system diagram illustrating a configuration for a data center that can be utilized to implement aspects of the technologies disclosed herein.

FIG. 7 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes techniques for an email system to link emails related to the same transaction and detect fraud. A method to perform the techniques described herein includes receiving, at an email platform, a first email to be delivered to an email account of a user registered with an email service. Further, the method includes determining that the first email includes a unique identifier representing a transaction indicated by the first email and first email metadata representing first attributes of the transaction. The method further includes receiving, at the email platform, a second email to be delivered to the email account of the user registered with the email service, the second email being received independently of the first email. Additionally, the method includes determining that the second email includes the unique identifier representing the transaction indicated by the second email and second email metadata representing second attributes of the transaction. Further, the method includes determining, based at least in part on the unique identifier being included in the first email and the second email, and one the first email metadata and the second email metadata each representing details of the transaction, that the first email and the second email are both linked to the transaction. The method further includes analyzing the first email metadata with respect to the second email metadata to detect consistencies between the first email and the second email. Further, the method includes, based at least in part on the analyzing, causing the second email to be transmitted to the user such that the email account includes an indication of the first email and second email being linked.

Additionally, the techniques described herein may be performed by a system and/or device having non-transitory computer-readable media storing computer-executable instructions that, when executed by one or more processors, performs the method described above.

### EXAMPLE EMBODIMENTS

This disclosure describes techniques for an email system to link emails related to the same transaction and detect fraud. Traditionally, messaging service providers may present more than one email as an email thread, which may group emails together chronologically. However, these email threads are grouped based on subsequent emails being responsive to (e.g., replying, forwarding, etc.) an original email. In some instances, emails related to the same transaction (e.g., an e-commerce transaction) may be sent by different entities (e.g., merchants, payment processors, shipping carriers, etc.) such that transaction-related emails may be siloed from one another because they are not responsive to an original email. In such instances, transaction-related emails may be scattered through a user's inbox, and critical information or actions may be overlooked. Further, cloud messaging services provide secure email gateways (SEGs) and/or Secure Mailboxes (SMBs) that monitor emails for malicious content and implement pre-delivery protection by blocking email-based threats before they reach a mail server. These SEGs and SMBs can scan incoming, outgoing, and internal communications for signs of malicious or harmful content. However, the siloed nature of emails from different entities, but pertaining to the same transaction, may make it difficult for the SEGs and SMBs to detect transaction fraud, particularly when a user engages in a large number of transactions.

According to the techniques described herein, an email service provider may receive an email (or another type of message) that is to be delivered to a user of an email service. An email processing system of the service provider may also extract header information associated with the email. The email processing system may extract recipient information (e.g., from standard headers). The email processing system may also determine that the email is associated with a transaction. For example, the email processing system may determine an intent associated with the email (payment, shipping, receipt, etc.) and/or a domain associated with the email (e.g., e-commerce, life insurance, etc.). The email processing system may also be configured to extract unique identifiers and/or transactional metadata in the email body or attachments, sender data, timestamp data, product details, etc. A unique identifier (order number, confirmation number, etc.) of the incoming email may be used by the email processing system to match the transaction of the incoming email to transactions of previously-received emails. For example, a transaction of a previously-received email may include the same unique identifier as the unique identifier extracted from the incoming email. Additionally, or alternatively, the email processing system may match the transaction of the incoming email to transactions of previously-received emails based on other transactional metadata. Based on a transaction match between emails meeting or exceeding a threshold confidence score (e.g., the unique identifier and/or transactional metadata indicate a sufficient match), the email processing system may be configured to link the incoming email to one or more previously-received emails, as well as update a transaction table to reference the linkage between the emails. The incoming email may be delivered to a user account (e.g., user inbox) such that the incoming email is delivered as an email thread or otherwise consolidated with the one or more previously-received emails.

To implement the techniques described herein, an email service platform may use, or work in combination with, an email processing system. The email processing system may include a security system (e.g., a SEG) that may receive, or intercept, emails and/or other types of electronic communications that are to be communicated to users of the email service platform, such as being stored at a location that is accessible to the users via their respective inboxes. As described herein, an email received by the email processing system may include, or be associated with, a transaction. A transaction may be associated with e-commerce (e.g., a purchase of an item), financial transfers (e.g., transferring cash to a bank), services (e.g., purchasing an insurance policy) and/or other exchanges that may occur via an online platform. In some instances, the email processing system may be configured to extract X-header information associated with the email. For example, the email processing system may be configured to extract an X-transaction-ID associated with the email, where the X-transaction-ID may be added as an X-header to the email and signed by the entity sending the email. For example, the entity sending the email may include a merchant, insurance company, and/or the like. Additionally, or alternatively, the email processing system may be configured to extract X-transaction-domains, where the X-transaction-domains may indicate an authorized entity, brand, company, etc. for a transaction. By way of example, and not limitation, an X-transaction-domain may indicate authorized shipping carriers, payment systems, and/or the like for a particular transaction. This way, emails associated with the same transaction, but sent independently from one another, may be linked based on the X-transaction-ID and/or X-transaction-domains, and delivered to the user account as an email thread.

In some instances, the email processing system may be configured to link emails sent independently from one another based on a unique identifier, transactional metadata, etc. In some instances, the email processing system may link the emails in instances where no X-transaction-ID or X-transaction-domain is present. For example, after receiving an email for a user (e.g., a receiving user) of the email service platform, the email processing system may be configured to extract recipient information associated with the email. For example, the email processing system may be configured to parse through a header of the email (e.g., “To-Field” addresses for the email).

The email processing system may also be configured to analyze the content of an email for a user of the email service platform. For example, the email processing system may be configured to determine an intent associated with the email. An intent may include one more actions associated with a transaction of the email. By way of example, and not limitation, an intent may include payment, receipt, shipping, confirmation, and/or the like associated with a transaction of the email. In other words, an intent determined by the email processing system may include an action associated with a particular entity and associated with at least a portion, or step, of the transaction (e.g., shipping portion, payment portion, receipt portion, etc.). Additionally, or alternatively, the email processing system may be configured to determine a domain (e.g., subject matter domain) associated with the email. A domain may include the context within which the transaction of the email occurs. By way of example, and not limitation, a domain may include e-commerce, banking, insurance, and/or the like. The email processing system may determine the intent and/or domain based on the content of the email. For example, the content of an email may include a body of the email indicating that “your package has shipped.” Based on the content of the email, the email processing system may determine that the intent is shipping, and the domain is e-commerce. In another example, the content of an email may include a body of the email indicating that “the premium payment towards your insurance policy was successfully processed.” Based on the content of the email, the email processing system may determine that the intent is receipt, and the domain is insurance.

In some instances, the email processing system may be configured to extract email metadata (e.g., transactional metadata) associated with the content of an email, header fields of emails (e.g., “From-Field” addresses, “To-Field” addresses, Subject, etc.), attachments associated with the email, links and/or URLs associated with the email, and/or the like. For example, transactional metadata may include one or more unique identifiers (e.g., order number, transaction identifier, reference number, etc.). Additionally, or alternatively, transactional metadata may include invoice and/or receipt details (e.g., time and date of the transaction, costs associated with the transaction, etc.), seller details (e.g., seller name, seller logo, etc.), shipper details (e.g., shipper name, shipper logo, etc.), product details (e.g., product, brand name, cost, etc.), transaction status (e.g., payment debited, payment received, etc.), and/or other data associated with the transaction of the email. In other words, the transactional metadata may include one or more attributes associated with the transaction of the email.

Based on a unique identifier of the email and/or other transactional metadata, the email processing system may be configured to match, or link, the transaction of an incoming email to a previously-received email by the user of the email service (e.g., the recipient of the incoming email). Alternatively, and as described in more detail below, the email processing system may be configured to update a transaction database. In some instances, the email processing system may be configured to directly correlate an incoming email sent by an entity to a previously-received email sent by a different entity using transactional metadata such as unique identifiers. For example, the email processing system may receive an incoming email indicating a transaction associated with a first entity. The email processing system may have previously received an email indicating a transaction associated with a second entity. The email processing system may determine that a unique identifier, such as an order number, of the incoming email sent by a first entity matches, or is consistent with, a unique identifier of the previously-received email sent by the second entity. Accordingly, the email processing system may correlate the transaction associated with the incoming email to the transaction of the previously-received email. In other words, the email processing system may determine that the incoming email sent by the first entity and the previously-received email sent by the second entity are linked to the same transaction.

Additionally, or alternatively, the email processing system may be configured to link the transaction of an incoming email to the transaction of a previously-received email by a reference, or chain, of multiple unique identifiers. For example, the incoming email from the first entity may be associated with multiple unique identifiers. By way of example, the incoming email may include a unique identifier, such as an order number. Further, the incoming email may include a unique identifier, such as a shipment tracking number, in the body of the email (e.g., a shipment tracking number extracted by the email processing system as transactional metadata associated with the content of the email). The previously-received email sent by the second entity may include a unique identifier that matches the unique identifier of the shipment tracking number of the incoming email. Accordingly, the email processing system may correlate the transaction associated with the incoming email to the transaction of the previously-received email.

Additionally, or alternatively, the email processing system may be configured to correlate the incoming email to the previously-received email based on transactional metadata (e.g., in the absence of a unique identifier, or in combination with a unique identifier). For example, the incoming email from the first entity may include an amount debited by the first entity, a date and time of the transaction, a brand name, and/or the like. The previously-received email sent by the second entity may include an amount received by the second entity that is consistent with the amount debited by the first entity. Additionally, or alternatively, the previously-received email may include an indication of the same (e.g., consistent) brand name and/or the data and time of the transaction. Accordingly, the email processing system may correlate the transaction associated with the incoming email to the transaction of the previously-received email.

The email processing system may be configured to determine a confidence score associated with a correlation between transactions (e.g., the consistency between attributes of the transaction associated with the incoming email and the attributes of the transaction of the previously-received email). By way of example, and not limitation, a confidence score may indicate a confidence within a confidence range of 0-100. However, in other examples, the upper and/or lower bounds for the confidence range could be higher or lower, and/or the confidence range could be larger or smaller. As described above, the email processing system may be configured to directly correlate, correlate by reference, and/or correlate based on transactional metadata the incoming email to the previously-received email. For example, the email processing system may determine that the unique identifier of the incoming email matches the unique identifier of the previously-received email. Based on the unique identifiers matching, the email processing system may determine a confidence score of 70. Additionally, or alternatively, a confidence score may be increased (e.g., indicating a higher confidence) based on other matches, such as matching other data and/or transactional metadata. By way of example, and not limitation, the domain of the incoming email may match the domain of the previously-received email (e.g., both domains are e-commerce domains). Additionally, or alternatively, the intent of an incoming email may match the intent of the previously-received email (e.g., the intent of the previously-received email is payment and the intent of the incoming email is shipping). Additionally, or alternatively, the price of the transaction associated with the incoming email may match the price of the transaction associated with the previously-received email. Based on one or more additional matches (e.g., matches using metadata), the email processing system may increase the confidence score of 70 to a confidence score of 99.

The email processing system may be configured to determine if the confidence score meets or exceeds a threshold confidence score to link an incoming email to a previously-received incoming email. For example, as described above, the unique identifier of an incoming email may match the unique identifier of a previously-received email, where the email processing system may then determine a confidence score of 70. In some instances, the confidence score of 70 may not meet or exceed a threshold confidence score (e.g., if the threshold confidence score is 75). Additionally, or alternatively, based on one or more additional matches (e.g., matches using metadata), the email processing system may increase the confidence score to 99. This way, the confidence score may exceed the threshold confidence score. The threshold confidence score may be contextually-based. By way of example, and not limitation, the threshold confidence score may be determined based on context associated with an incoming email, such as whether the email comprises a transaction including a large sum of money. Additionally, or alternatively, the threshold confidence score may be set by an administrator (e.g., administrator associated with the email service) based on one or more policies. Policies for the threshold confidence score may be adjusted continuously, periodically, etc.

In instances where a confidence score for a match between an incoming email and a previously-received email meets or exceeds the threshold confidence score, the email processing system may be configured to link the incoming email and the previously-received email. By way of example, and not limitation, each email may be associated with a message identifier. For example, the previously-received email sent by a second entity may include a message identifier such as “MsgId1.” Additionally, or alternatively, the incoming email sent by a first entity may include a message identifier such as “MsgId2.” Using the message identifiers, the email processing system may determine reference data, where the reference data indicates a linkage between the incoming email and the previously-received email. For example, reference data may include an addition and/or modification to an “In-Reply-To” header of the incoming email and by the email processing system. The addition and/or modification to the “In-Reply-To” header may include an indication of the message identifier of the previously-received email (e.g., MsgId1). Additionally, or alternatively, the reference data may indicate linkage, or a reference, between the incoming email, the previously-received email, and/or other previously-received emails as part of an email “thread” (e.g., with a message identifier of MsgId3). For example, reference data may include an addition and/or modification to a “References” header of the incoming email and by the email processing system. The addition and/or modification to the “References” header may include an indication of the message identifier of the previously-received email and the email thread (e.g., MsgId1 and MsgId3).

Based on the reference data, the email processing system may be configured to forward and/or transmit an email to a receiving user such that the email is delivered to the receiving user's inbox. For example, the email processing system may forward and/or transmit the incoming email such that the incoming email is displayed as being consolidated (e.g., threaded to, or in conversation) with the previously-received email at the user's inbox. This way, emails received from different entities independently, but comprising at least a portion of the same transaction, may be displayed as if the emails were in reply to one another. In some instances, an incoming email may be linked, and subsequently consolidated with, an existing email thread. For example, the incoming email may be linked to any of the previously-received emails, alone or in combination, of an existing email thread, and the emails of the email thread (e.g., incoming email and previously-received emails) may be consolidated in more than one order. Additionally, or alternatively, the email processing system may be configured to update a database of transactions and/or metadata to indicate the linkage (e.g., reference data) between an incoming email and one or more previously-received emails. The database may include one or more tables including linked emails, as well as other email attributes such as intent, domain, message identifier, unique identifier, transactional metadata, and/or references (e.g., linked emails).

In instances where a confidence score for a match between an incoming email and a previously-received email does not meet or exceed the threshold confidence score, the email processing system may be configured to refrain from linking the incoming email and the previously-received email. Additionally, or alternatively, a confidence score not meeting or exceeding the threshold confidence score may indicate an insufficient match (e.g., a confidence score of 70) or the non-existence of a match. For example, the incoming email may be the first email received by the email processing system pertaining to a transaction. As such, the email processing system may be configured to update the database of transactions and/or metadata to indicate the attributes associated with the incoming email (e.g., intent, domain, message identifier, unique identifier, and/or transactional metadata). This way, subsequent emails received by the email processing system and pertaining to the same transaction may be linked to the incoming email. The email processing system may be configured to forward and/or transmit the incoming email to the receiving user such that the incoming email is delivered to the receiving user's inbox. The email processing system may forward and/or transmit the incoming email such that the incoming email is displayed independently from, or unconsolidated with, previously-received emails at the user's inbox.

Additionally, or alternatively, the email processing system may be configured to identify anomalies, or inconsistencies, between emails pertaining to at least a portion of the same transaction, and in turn, detect a fraudulent email. In some instances, the email processing system may receive an incoming email, which may be an initiating email for a transaction (e.g., an email from an order portal). Additionally, or alternatively, the email processing system may extract transactional metadata such as unique identifiers, sender details, timestamps, etc. Because the incoming email is an initiating email for the transaction, the email processing system may be configured to update the database of transactions and/or metadata to indicate the incoming email (hereinafter “initiating email”) and attributes associated with the initiating email (e.g., unique identifier, email domains, sender details, timestamps, etc.). The initiating email may then be transmitted to the receiving user such that the initiating email is delivered to the receiving user's inbox.

The email processing system may then receive one or more subsequent emails after receipt and delivery of the initiating email. As described above, the email processing system may similarly extract transactional metadata associated with a subsequent email such as unique identifiers, sender details, timestamps, etc. In some instances, the email processing system may determine whether a unique identifier of a subsequent email exists in the database (e.g., matches a previously-received email, or the initiating email). If there is a match between unique identifiers, the email processing system may determine whether the subsequent email is a valid email with respect to the transaction of the initiating email. For example, the email processing system may determine whether there are anomalies, or inconsistencies, between the transactional metadata of the initiating email and the subsequent email. For example, transaction metadata of the initiating email may indicate a time and date associated with a transaction that is inconsistent with a time and date indicated by the subsequent email (e.g., the shipping date indicated by the subsequent email is months later after the date of a purchase from an order portal), despite the initiating email and the subsequent email both including the same unique identifier. Based on one or more inconsistencies, the email processing system may be configured to determine that the subsequent email is invalid. In instances where a subsequent email is invalid, the subsequent email may not be consolidated with the initiating email in the receiving user's inbox. Additionally, or alternatively, in instances where a subsequent email is invalid, the email processing system may process the email accordingly. For example, the email processing system may be configured to perform a remedial action with respect to the invalid email. Remedial actions may include quarantining, flagging, deleting, and/or dropping the invalid email, preventing further communication received from the sender and/or further communication sharing similarities with the invalid email, blocking and/or flagging the invalid email, reporting sender information to authorities, and/or the like.

The techniques described herein improve the functioning of email service platforms as well as email security platforms. For example, email service providers may present more than one email as an email thread, which may group emails together chronologically. However, these email threads are grouped based on subsequent emails being responsive to (e.g., replying, forwarding, etc.) an original email. In some instances, emails related to the same transaction (e.g., an e-commerce transaction) may be sent by different entities (e.g., merchants, payment processors, shipping carriers, etc.) such that transaction-related emails may be siloed from one another because they are not responsive to an original email. In such instances, transaction-related emails may be scattered through a user's inbox, and critical information or actions may be overlooked. Accordingly, the techniques described herein may increase efficiencies around the scanning and delivery of emails, which in turn may improve utilization of computing resources. Additionally, or alternatively, linking transaction-related emails may increase the likelihood that all relevant emails will be seen by the user.

Additionally, malicious emails and/or electronic messages may include an indication of a fraudulent transaction (e.g., invoice fraud). Email security platforms are provided by messaging service providers (and/or third-party security service providers) that attempt to identify and eliminate attacks on email communication channels. SEGs and SMBs can scan incoming, outgoing, and internal communications for signs of malicious or harmful content. However, the siloed nature of emails from different entities, but pertaining to the same transaction, may make it difficult for the SEGs and SMBs to detect transaction fraud, particularly when a user engages in a large number of transactions. Accordingly, the techniques described herein may increase efficiencies around the detection and prevention of transaction fraud in emails and/or other electronic communications, and thus preventing disastrous implications for individuals, enterprises, businesses, and/or the like (e.g., financial loss, emotional damage, etc.). Additionally, the determination and use of unique identifiers and transactional metadata may improve the utilization of computing resources (e.g., reduce the number of necessary VM instances to be spun up to determine malicious intent), and thus reduce customer costs.

The techniques described herein are with reference to a service provider network, such as a cloud provider network or platform, and networks such as VPCs, subnetworks (or “subnets”). However, the techniques are equally applicable to any network and in any environment. For example, the message processing service may monitor an on-premises network.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

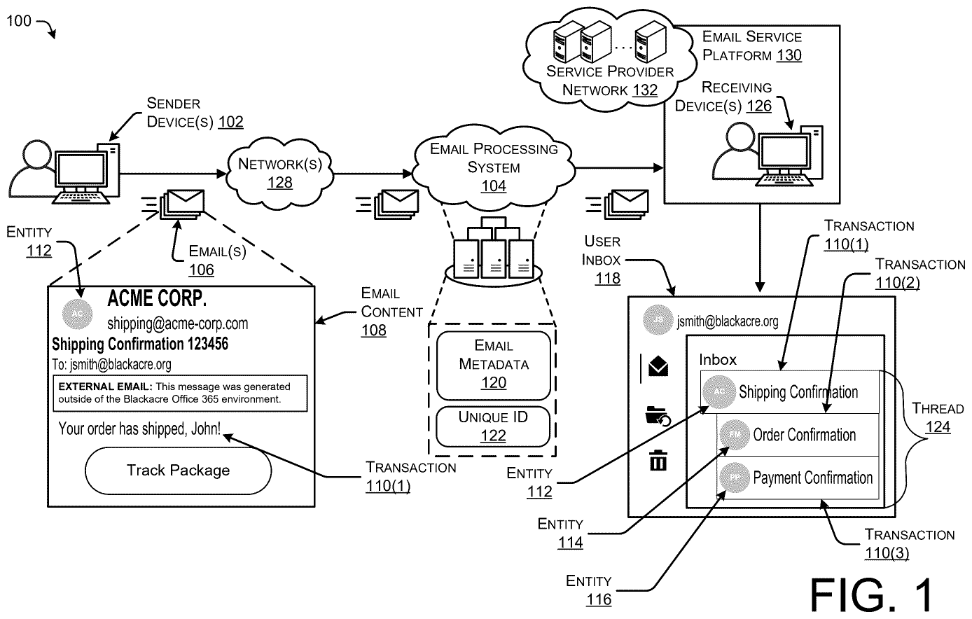

FIG. 1 illustrates an example environment 100 in which an email processing system 104 determines whether an incoming email 106 is related to the same transaction 110 as one or more other emails, and linking the incoming email 106 accordingly.

In some examples, an email service platform 130 may be at a service provider network 132. The service provider network 132 may be or comprise a cloud provider network. A cloud provider network (sometimes referred to simply as a “cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to user commands. In other instances, however, the service provider network 132 may be an on-premises network, a private network of a corporation, and/or any other type of network or combination thereof.

Additionally, or alternatively, an email service platform 130 may use, or work in combination with, an email processing system 104. The email processing system 104 may be a scalable system that includes and/or runs on devices housed or located in one or more data centers, that may be located at different physical locations. In some examples, the email processing system 104 may be included in the email service platform 130 and/or associated with a SEG. The email processing system 104 and the email service platform 130 may be supported by networks of devices in a public cloud computing platform, a private/enterprise computing platform, and/or any combination thereof. The one or more data centers may be physical facilities or buildings located across geographic areas that are designated to store network devices that are part of and/or support the email processing system 104. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as process (CPU), memory (RAM), storage (disk), and networking (bandwidth).

The email processing system 104 may be associated with the email service platform 130 of an email service provider, and may generally comprise any type of email and/or service provided by any provider, including public messaging service providers (e.g., Google Gmail, Microsoft Outlook, Yahoo! Mail, etc.), as well as private messaging service platforms maintained and/or operated by a private entity or enterprise. Further, the email service platform 130 may comprise cloud-based messaging service platforms (e.g., Google G Suite, Microsoft Office 365, etc.) that host messaging services. However, the email service platform 130 may generally comprise any type of platform for managing communication between clients or users, such as an email platform, a simple messaging service (SMS) platform, an audio/video communication platform, and so forth. The email service platform 130 may generally comprise a delivery engine behind email communications and include the requisite software and hardware for delivering email communications between users. For instance, an entity may operate and maintain the software and/or hardware of the email service platform 130 to allow users to send and receive emails, store and review emails in inboxes, manage and segment contact lists, build email templates, manage and modify inboxes and folders, scheduling, and/or any other operations performed using the email service platform 130.

The email service platform 130 may provide one or more messaging services to users of receiving devices 126 (or any type of user device) to enable the receiving devices 126 to communicate and/or receive emails. Sender devices 102 may communicate with receiving devices 126 over networks 128, such as the Internet. In some instances, the networks 128 may generally comprise one or more networks implemented by any viable communication technology, such as wired and/or wireless modalities and/or technologies. The networks 128 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed-and/or any combination, permutation, and/or aggregation thereof. The networks 128 may include devices, virtual resources, or other nodes that relay packets from one device to another.

User devices, such as the sender devices 102 that send emails 106 and the receiving devices 126 that receive the emails, may comprise any type of electronic device capable of communicating using email communications. For instance, the devices 102/126 may include one or more of different personal user devices, such as desktop computers, laptop computers, phones, tablets, wearable devices, entertainment devices such as televisions, and/or any other type of computing device. Thus, the devices 102/126 may utilize the email service platform 130 to communicate using emails based on email address domain name systems according to techniques known in the art.

As illustrated, the email processing system 104 may receive, or intercept, emails 106 and/or other types of electronic communications that are to be communicated to users (e.g., receiving devices 126) of the email service platform 130, such as being stored at a location that is accessible to the users via their respective inboxes. An email 106 received by the email processing system 104 may include, or be associated with, at least a portion of a transaction 110(1). A transaction 110(1) may be associated with e-commerce (e.g., a purchase and receipt of an item). After receiving an email 106, the email processing system 104 may be configured to analyze the content 108 of the email 106. In some instances, the email processing system 104 may be configured to extract and/or use transactional metadata (e.g., email metadata 120) associated with the content 108 of the email 106, attachments associated with the email 106, links and/or URLs associated with the email 106, and/or the like. Email metadata 120 may include, or be associated with, a unique identifier 122, which may include an order number, transaction identifier, reference number, and/or the like. Email metadata 120 may include invoice and/or receipt details (e.g., time and date of the transaction, costs associated with the transaction, etc.), seller details (e.g., seller name, seller logo, etc.), shipper details (e.g., shipper name, shipper logo, etc.), product details (e.g., product, brand name, cost, etc.), transaction status (e.g., payment debited, payment received, etc.), and/or other data associated with the transaction of the email. In some instances, the email 106 may be associated with, or sent by, a particular entity, such as entity 112. As illustrated, entity 112 of email 106, which may be associated with the sender devices 102, may be a shipping entity.

Based on a unique identifier 122 of the email 106 and/or email metadata 120, the email processing system 104 may be configured to match, or link, the transaction 110(1) of email 106 to a previously-received email by the user of the email service platform 130. In some instances, the email processing system 104 may be configured to correlate the email 106 sent by entity 112 to a previously-received email sent by a different entity, such as entity 114 and entity 116. For example, the email processing system 104 may receive email 106 indicating the transaction 110(1) associated with entity 112. The email processing system 104 may have previously received an email indicating a transaction associated with other entities. For example, the email processing system 104 may have received an email including transaction 110(2) associated with entity 114, and an email including transaction 110(3) associated with entity 116. The email processing system 104 may determine that unique identifier 122 of the email 106 matches a unique identifier 122 of the previously-received email sent by entity 114 and/or entity 116. Accordingly, the email processing system 104 may correlate the transaction 110(1) associated with the email 106 to the transactions 110(2) and 110(3) of the previously-received emails. In other words, the email processing system 104 may determine that the email 106 sent by the entity 112 and the previously-received emails sent by the entities 114 and 116 comprise the same transaction (e.g., transaction 110).

In some instances, the email processing system 104 may be configured to link the email 106 and the previously-received emails. For example, based on the email 106 comprising the same transaction 110 as the previously-received emails, the email processing system 104 may be configured to forward and/or transmit the email 106 to a receiving user such that the email 106 is delivered to the receiving user's inbox 118. For example, the email processing system 104 may forward and/or transmit the email 106 such that the incoming email 106 is displayed as a thread 124 with the previously-received email at the user's inbox 118. This way, even though the email 106 from entity 112 was received independently from previously-received emails from entities 114 and 116, the email 106 may be included as part of thread 124 as if the emails were in reply to one another. It is to be appreciated that the transaction 110(1) of the email 106 may be linked to any one, or combination, of the emails from entity 114 and/or entity 116. For example, the email 106 from entity 112 may be linked to the email from entity 114, but not the email from entity 116. However, all three emails may be included as part of the thread 124 (e.g., in instances where there is a link between the email from entity 114 and the email from entity 116).

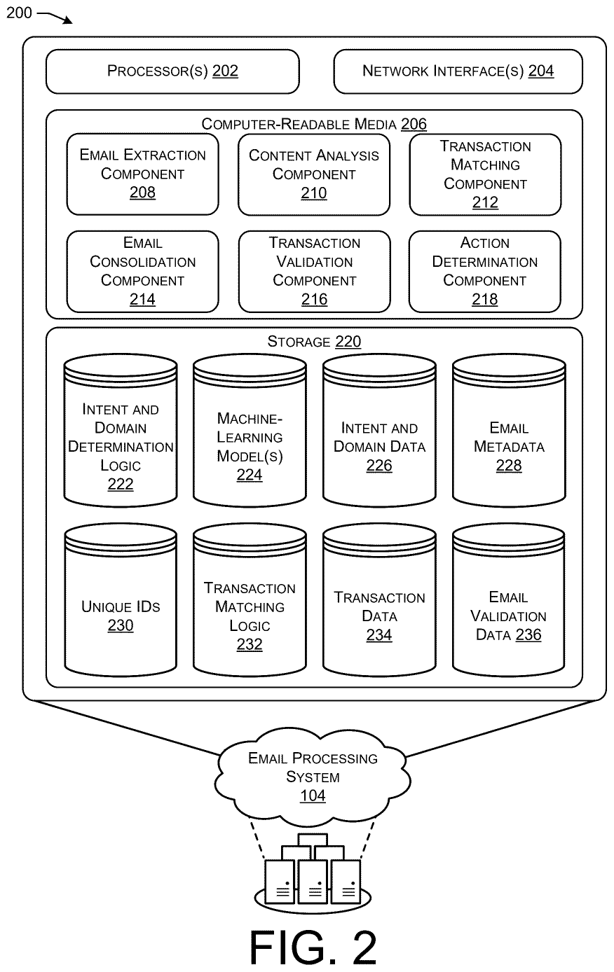

FIG. 2 illustrates a component diagram 200 of an example email processing system 104 that links independent emails from different entities, but pertaining the same transaction. As illustrated, the email processing system 104 may include one or more hardware processors 202 (processors), one or more devices, configured to execute one or more stored instructions. The processor(s) 202 may comprise one or more cores. Further, the email processing system 104 may include one or more network interfaces 204 configured to provide communications between the email processing system 104 and other devices, such as the sender device 102, receiving devices 126, and/or other systems or devices associated with an email service providing the email communications. The network interfaces 204 may include devices configured to couple to personal area networks (PANs), wired and wireless local area networks (LANs), wired and wireless wide area networks (WANs), and so forth. For example, the network interfaces 204 may include devices compatible with Ethernet, Wi-Fi™, and so forth.

The email processing system 104 may also include computer-readable media 206 that stores various executable components (e.g., software-based components, firmware-based components, etc.). The computer-readable media 206 may store components to implement functionality described herein. While not illustrated, the computer-readable media 206 may store one or more operating systems utilized to control the operation of the one or more devices that comprise the email processing system 104. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 206 may include portions, or components, that configure the email processing system 104 to perform various operations described herein. For example, an email extraction component 208 may be configured to, when executed by the processor(s) 202, perform various techniques for extracting header information (e.g., recipient information), unique identifiers, and/or email metadata (e.g., transaction metadata). A unique identifier may include an order number, transaction identifier, reference number, and/or the like. Email metadata may include, for example, indications of email content such as “From-Field” addresses and/or names for the email, “To-Field” addresses for the email, a “Subject” of the email, a date and/or time the email was communicated, hashes of attachments to the email, URLs in the body of the email, IP addresses associated with the email, and/or a domain associated with the email. In some instances, the email metadata may additionally, or alternatively, include content included in the body of the email, actual attachments, and/or the like. The email metadata may additionally, or alternatively, include transactional metadata such as invoice and/or receipt details (e.g., time and date of the transaction, costs associated with the transaction, etc.), seller details (e.g., seller name, seller logo, etc.), shipper details (e.g., shipper name, shipper logo, etc.), product details (e.g., product, brand name, cost, etc.), transaction status (e.g., payment debited, payment received, etc.), and/or other data associated with the transaction of the email.

The computer-readable media 206 may further include a content analysis component 210 that may configure the email processing system 104 to perform various operations described herein. For instance, the content analysis component 210 may be configured to, when executed by the processor(s) 202, perform various techniques for determining intent and domains associated with an email. An intent may include one more actions associated with a transaction of the email. By way of example, and not limitation, an intent may include payment, receipt, shipping, confirmation, and/or the like associated with a transaction of the email. In other words, an intent determined by the email processing system may include an action associated with a particular entity and comprising at least a portion of the transaction (e.g., shipping, payment, receipt, etc.). A domain may include the context within which the transaction of the email occurs. By way of example, and not limitation, a domain may include e-commerce, banking, insurance, and/or the like. The email processing system may determine the intent and/or domain based on the content of the email.

The computer-readable media 206 may further include a transaction matching component 212 that may configure the email processing system 104 to perform various operations described herein. For instance, the transaction matching component 212 may be configured to, when executed by the processor(s) 202, perform various techniques for determining a match between the transaction of an incoming email to a transaction of a previously-received email. The transaction matching component 212 may utilize policies and/or rules to analyze unique identifiers, email metadata, etc. to determine whether there is a match between the transaction of an incoming email to the transaction of a previously-received email.

The computer-readable media 206 may further include an email consolidation component 214 that may configure the email processing system 104 to perform various operations described herein. For instance, the email consolidation component 214 may be configured to, when executed by the processor(s) 202, perform various techniques for consolidating independently-received emails from different entities based on a confidence score meeting or exceeding a threshold confidence score. The email consolidation component 214 may utilize policies and/or rules to determine a confidence score associated with the correlation between transactions. The email consolidation component 214 may also utilize policies and/or rules to determine a threshold confidence score. Additionally, or alternatively, the email consolidation component 214 may also utilize policies and/or rules to modify and/or add headers of emails to include message identifiers of linked emails.

The computer-readable media 206 may further include a transaction validation component 216 that may configure the email processing system 104 to perform various operations described herein. For instance, the transaction validation component 216 may be configured to, when executed by the processor(s) 202, perform various techniques for determining whether a subsequent email is a valid email to be consolidated with an initiating email. For example, the transaction validation component 216 may utilize policies and/or rules to analyze the transaction identifier, authorized email domains, and/or email metadata (e.g., email metadata) to determine if a subsequent email comprising a transaction is a valid email for an initiating email comprising the same transaction.

The computer-readable media 206 may further include action determination component 218 that may configure the email processing system 104 to perform various operations described herein. For instance, the action determination component 218 may be configured to, when executed by the processor(s) 202, perform various techniques for forwarding and/or transmitting an email to a receiving user such that the email is delivered to the receiving user's inbox and displayed as being consolidated with a previously-received email at the user's inbox and comprising the same transaction. Additionally, or alternatively, the action determination component 218 may utilize policies and/or rules to determine a remedial action with respect to the invalid email. Remedial actions may include quarantining, flagging, deleting, and/or dropping the invalid email, preventing further communication received from the sender and/or further communication sharing similarities with the invalid email, blocking and/or flagging the invalid email, reporting sender information to authorities, and/or the like.

The above-noted list of components and their respective processes are merely exemplary, and other types of security policies may be used to analyze the email and/or phone number metadata.

Additionally, the email processing system 104 may include storage 220 which may comprise one, or multiple, repositories or other storage locations for persistently storing and managing collections of data such as databases, simple files, binary, and/or any other data. The storage 220 may include one or more storage locations that may be managed by one or more storage/database management systems.

As illustrated, the storage 220 may include intent and domain determination logic 222, ML model(s) 224, intent and domain data 226, email metadata 228, unique IDs 230 transaction matching logic 232, transaction data 234, and/or email validation data 236. It should be appreciated that the foregoing list is merely exemplary and the storage 220 may include additional elements that may be apparent to one skilled in the art.

The intent and domain determination logic 222 may include a database of logic for determining an intent associated with an email (e.g., whether the email is associated with payment, shipping, receipt, etc.). The intent and domain determination logic 222 may also include a database of logic for determining a domain associated with an email (e.g., e-commerce, insurance, etc.) For example, content analysis component 210 may reference intent and domain determination logic 222 and email metadata 228 in determining an intent and domain associated with an email.

The ML model(s) 224 may include a database of machine learning algorithms. The ML model(s) may include one or more algorithms including supervised, semi-supervised, unsupervised, and/or reinforcement. In some examples, the processor(s) 202 train(s) the email processing system 104 utilizing machine learning techniques, statistical analysis, or any other means by which a system may be trained to output a match, or link, between independent emails from different entities, but comprising the same transaction, based on intent and domain data 226, unique IDs 230, email metadata 228, and/or other data associated with the storage 220.

The intent and domain data 226 may include a database of intents and domains determined by the content analysis component 210. An intent may include one more actions associated with a transaction of the email. By way of example, and not limitation, an intent may include payment, receipt, shipping, confirmation, and/or the like associated with a transaction of the email. In other words, an intent determined by the email processing system may include an action associated with a particular entity and comprising at least a portion of the transaction (e.g., shipping, payment, receipt, etc.). A domain may include the context within which the transaction of the email occurs. By way of example, and not limitation, a domain may include e-commerce, banking, insurance, and/or the like. Additionally, or alternatively, intent and domain data 226 may be a database of historically determined intents and domains.

The email metadata 228 may include a database of email metadata (e.g., metadata indicating the content, attributes, and/or other information associated with an email). Email metadata may include, for example, indications of “From-Field” addresses and/or names for the email, “To-Field” addresses for the email, a “Subject” of the email, a Date/Time the email was communicated, hashes of attachments to the email, URLs in the body of the email, Internet Protocol (IP) addresses associated with the email, and/or a domain associated with the email (e.g., the email server associated with an email address). In some instances, the metadata may additionally, or alternatively, include content included in the body of the email, actual attachments to the email, and/or other data of the email. While not illustrated, the email metadata may additionally, or alternatively, include transactional metadata such as one or more unique identifiers (e.g., order number, transaction identifier, reference number, etc.), such as unique IDs 230. Additionally, or alternatively, transactional metadata may include invoice and/or receipt details (e.g., time and date of the transaction, costs associated with the transaction, etc.), seller details (e.g., seller name, seller logo, etc.), shipper details (e.g., shipper name, shipper logo, etc.), product details (e.g., product, brand name, cost, etc.), transaction status (e.g., payment debited, payment received, etc.), and/or other data associated with the transaction of the email. Additionally, or alternatively, the email metadata 228 may be a database of historically received and/or extracted email metadata. While not illustrated, it is to be appreciated that email metadata 228 may include unique IDs 230.

Unique IDs 230 may include a database of unique identifiers determined by the email extraction component 208. A unique identifier may include an order number, transaction identifier, reference number, and/or the like. Additionally, or alternatively, the unique IDs may be a database of historically received and/or extracted unique identifiers.

The transaction matching logic 232 may include a database of logic for determining whether to match, or link, the transaction of an incoming email to a previously-received email. For example, the transaction matching component 212 may reference transaction matching logic 232, intent and domain data 226, unique IDs 230, and/or email metadata 228 in determining a match between transactions of independent emails from different entities. Additionally, or alternatively, the transaction validation component 216 may reference the transaction matching logic 232, intent and domain data 226, unique IDs 230, and/or email metadata 228 in determining whether a subsequent email for a transaction is valid with respect to an initiating email (e.g., email initiating the transaction).

The transaction data 234 may include a database of emails previously received by the email processing system 104. Transaction data 234 may include an indication (e.g., tables) of information associated with the emails, such as intent, domain, message identifier, unique identifiers, and/or transactional metadata. Transaction data 234 may also include references, or linkages, to one or more linked emails (e.g., message identifiers of linked emails). Message identifiers may include identifiers such as “MsgId1” and “MsgId2” which may be used to modify headers of emails, and in turn, link emails.

The email validation data 236 may include a database of data associated with valid and/or invalid emails. For example, the action determination component 218 may reference email validation data 236 to determine whether to perform a remedial action with respect to an invalid email. Remedial actions may include quarantining, flagging, deleting, and/or dropping the invalid email, preventing further communication received from the sender and/or further communication sharing similarities with the invalid email, blocking and/or flagging the invalid email, reporting sender information to authorities, and/or the like.

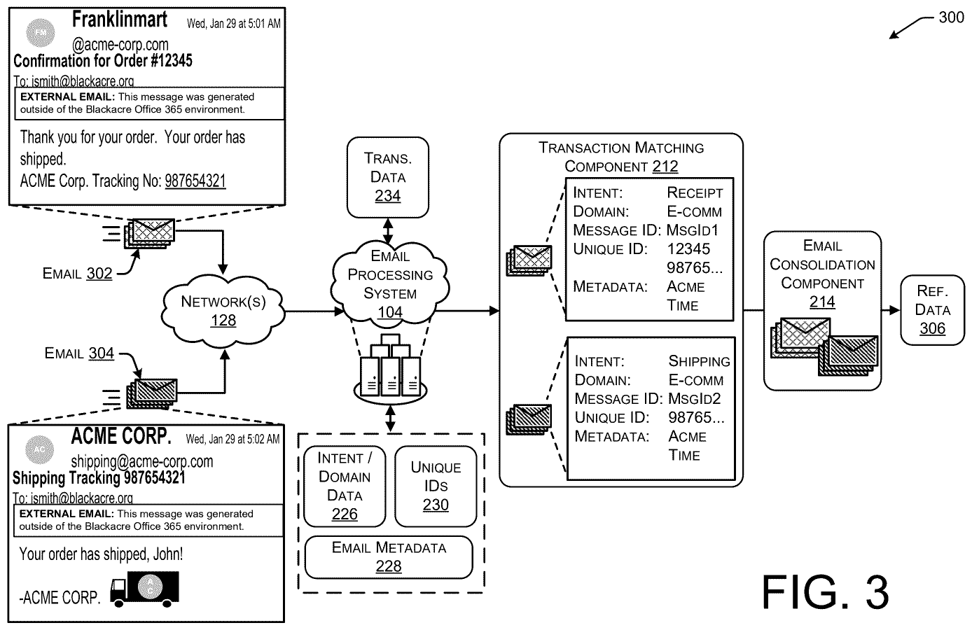

FIG. 3 illustrates an example environment 300 in which the email processing system 104 determines whether the transaction of an email corresponds to the transaction of another email based on transactional metadata.

As described above, sender devices may communicate with receiving devices (e.g., end users) to communicate and/or receive emails, where the sender devices may communicate with receiving devices over networks 128, such as the internet. The email processing system 104 may receive, or intercept emails (e.g., email 302 and/or email 304) that are to be communicated to receiving devices. For example, email processing system 104 may receive email 302. The email 302 may be associated with at least a portion of a transaction. As illustrated, the email 302 may be associated with a portion of a transaction such as an order confirmation. The email 302 may also be associated with a particular entity (e.g., Franklinmart). After receiving the email 302, the email processing system 104 may be configured to extract recipient information (e.g., jsmith@blackacre.org) and/or a unique identifier (e.g., 12345). As illustrated, the unique identifier is an order number. Additionally, or alternatively, the email processing system 104 may be configured to analyze the content of the email 302 to determine an intent associated with the email. Based on the email 302, the email processing system 104 may determine an intent of providing a receipt (e.g., an order confirmation). The email processing system 104 may also determine a domain associated with the email 302, where the domain may be e-commerce (e.g., based on the content of the email 302 including an indication of an order). The email processing system 104 may also be configured to extract transactional metadata associated with the email 302, such as a unique identifier in the body of the email (e.g., 987654321), seller details (e.g., Franklinmart), shipper details (e.g., ACME Corp.), and time and date of the transaction (e.g., Wednesday, January 29th at 5:01 AM). Based on the intent, domain, unique identifiers, and/or transactional metadata, the email processing system 104 may use, or work in combination with, transaction matching component 212 to match the transaction of the email 302 to the transaction of another email received by the email processing system 104. In some instances, the email 302 may be an initiating email (e.g., the first email received as part of a transaction). Accordingly, the email processing system may refrain from determining a match for the transaction of the email 302. Instead, the email processing system may store all extracted and determined attributes associated with the email. This information may be stored as transaction data 234.

Subsequently, email processing system 104 may receive email 304. The email 304 may be associated with at least a portion of a transaction. As illustrated, the email 304 may be associated with a portion of a transaction such as a shipping confirmation. Additionally, or alternatively, the email 304 may be associated with a particular entity (e.g., Acme Corp). After receiving the email 304, the email processing system 104 may be configured to extract recipient information (e.g., jsmith@blackacre.org) and/or a unique identifier (e.g., 987654321), such as unique ID 230. As illustrated, the unique ID 230 is a tracking number. Additionally, or alternatively, the email processing system 104 may be configured to analyze the content of the email 304 to intent and domain data 226 associated with the email. Based on the email 304, the email processing system 104 may determine an intent of shipping. The email processing system 104 may also determine that the domain associated with the email 304 is an e-commerce domain (e.g., based on the content of the email 304 including an indication of a shipment of an order). The email processing system 104 may also be configured to extract transactional metadata (e.g., email metadata 228) associated with the email 304, such shipper details (e.g., ACME Corp.) and/or time and date of the transaction (e.g., Wednesday, January 29th at 5:02 AM). Based on the intent and domain data 226, unique ID 230, and email metadata 228, the email processing system 104 may use, or work in combination with, transaction matching component 212 to match the transaction of the email 304 to the transaction of another email received by the email processing system 104. For example, the transaction matching component 212 may determine that the intent of the email 302 corresponds to the intent of the email 304 (e.g., receipt and shipping). Alternatively, if the intents of email 302 and 304 were both shipping, the transaction matching component 212 may not match the email 302 email 304 because it would be unlikely for a transaction to include two different shipping entities. The transaction matching component 212 may also determine that the domain of the email 302 corresponds to the domain of the email 304 (e.g., both are e-commerce domains). While there is not a match between the unique identifiers indicated in the header of each respective email (e.g., there is no direct linking between email 302 and email 304), the transaction matching component 212 may instead reference the unique identifier included in the body of the email 302 (e.g., 987654321) to the unique identifier of the email 304. In other words, the transaction matching component 212 may determine that a unique identifier of email 302 corresponds to the unique identifier of email 304 such that there is a referenced linking between email 302 and email 304. The transaction matching component 212 may also determine that the transactional metadata of email 302 corresponds to the transactional metadata of email 304. For example, the transactional metadata of email 302 and email 304 may indicate the same shipper details (e.g., ACME Corp.). Additionally, or alternatively, the transactional metadata of email 302 and email 304 may include date and time data in a particular chronological order.

Based on the one or more attributes corresponding, or matching, the email consolidation component 214 may determine a confidence score for the match between the email 302 and the email 304. The email consolidation component 214 may also determine whether the confidence score meets or exceeds a threshold confidence score. In instances where the confidence score meets or exceeds the threshold confidence score, the email processing system 104 may use, or work in combination with, the email consolidation component 214 to generate reference data 306. Reference data 306 may include an indication of a linkage between the message identifier of the email 302 (e.g., MsgId1) and the message identifier of the email 304 (e.g., MsgId2). While not illustrated, the reference data 306 may be usable by the email processing system 104 to add the message identifier of the email 302 to a “In-Reply-To” header of the email 304.

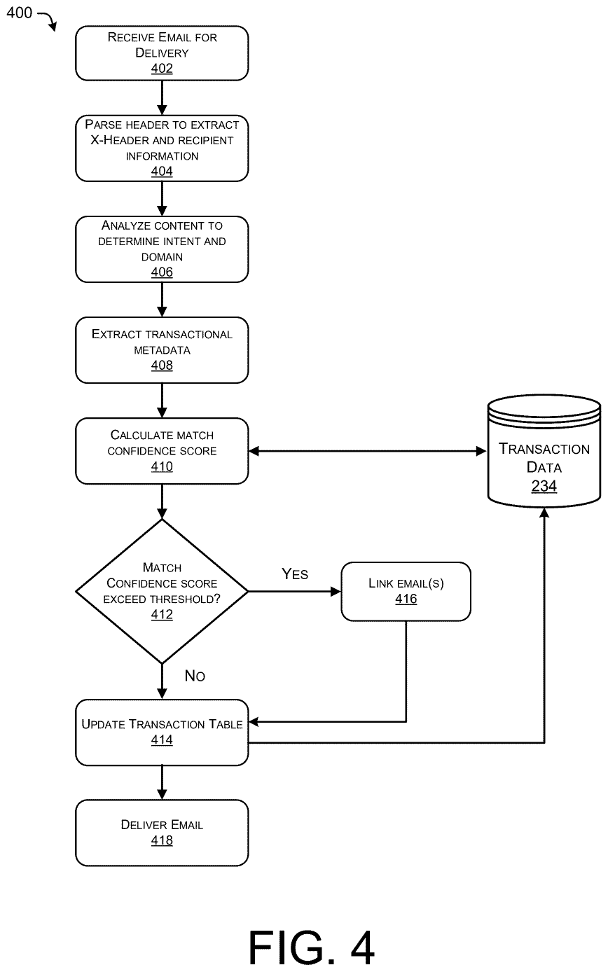

FIG. 4 illustrates a flow diagram of an example process 400 of transaction matching for incoming emails.

At operation 402, the email processing system 104 may receive an email to be delivered to a user of an email service platform.

At operation 404, the email processing system 104 may parse through a header of the email to extract recipient information and X-header information of the email, such as X-transaction-ID and/or X-transaction-domains.

At operation 406, the email processing system 104 may analyze the content of the email to determine an intent and domain associated with the email. An intent determined by the email processing system may include an action associated with a particular entity and comprising at least a portion of the transaction (e.g., shipping, payment, receipt, etc.). A domain may include the context within which the transaction of the email occurs (e.g., e-commerce, banking, insurance, and/or the like). In some instances, the process 400 may proceed to operation 406 in instances where, at operation 404, an email does not include an X-transaction-ID and/or X-transaction-domains.

At operation 408, the email processing system 104 may extract transactional metadata associated with the content of an email, attachments associated with the email, links and/or URLs associated with the email, and/or the like. For example, transactional metadata may include one or more unique identifiers (e.g., order number, transaction identifier, reference number, etc.). Additionally, or alternatively, transactional metadata may include invoice and/or receipt details (e.g., time and date of the transaction, costs associated with the transaction, etc.), seller details (e.g., seller name, seller logo, etc.), shipper details (e.g., shipper name, shipper logo, etc.), product details (e.g., product, brand name, cost, etc.), transaction status (e.g., payment debited, payment received, etc.), and/or other data associated with the transaction of the email.

At operation 410, the email processing system 104 may determine a match confidence score based on a correlation between transactions of two emails (e.g., the correlation of the transaction associated with the incoming email to the transaction of the previously-received email and indicated by transaction data 234). For example, the match confidence score may be determined based on matches, or correlations, between attributes of the two emails (e.g., unique identifiers, intent, domain, transactional metadata, etc.).

At operation 412, a determination by the email processing system 104 that the confidence score meets or exceeds a threshold confidence score (i.e., a “Yes” at operation 412), the process 400 may proceed to operation 416.

At operation 416, the email processing system 104 may link an incoming email and previously-received email. For example, the previously-received email sent by a second entity may include a message identifier such as “MsgId1.” Additionally, or alternatively, the incoming email sent by a first entity may include a message identifier such as “MsgId2.” Using the message identifiers, the email processing system may determine reference data, where the reference data indicates a linkage between the incoming email and the previously-received email.

At operation 412, a determination by the email processing system 104 that the confidence score does not meet or exceed the threshold confidence score (i.e., a “No” at operation 412), the process 400 may proceed to operation 414.

At operation 414 the email processing system 104 may update a database of transactions and/or metadata to indicate a linkage (e.g., reference data) or a lack thereof.

At operation 418, the email processing system 104 may forward and/or transmit the incoming email to the receiving user such that the incoming email is delivered to the receiving user's inbox. In instances where there is a linkage between an incoming email and a previously-received email (i.e., a “Yes” at operation 412), the incoming email may be transmitted such that the incoming email is displayed as a thread with the previously-received email. In instances where there is no linkage between an incoming email and a previously-received email (i.e., a “No” at operation 412), The email processing system may forward and/or transmit the incoming email such that the incoming email is displayed independently from, or unconsolidated with, previously-received emails at the user's inbox.

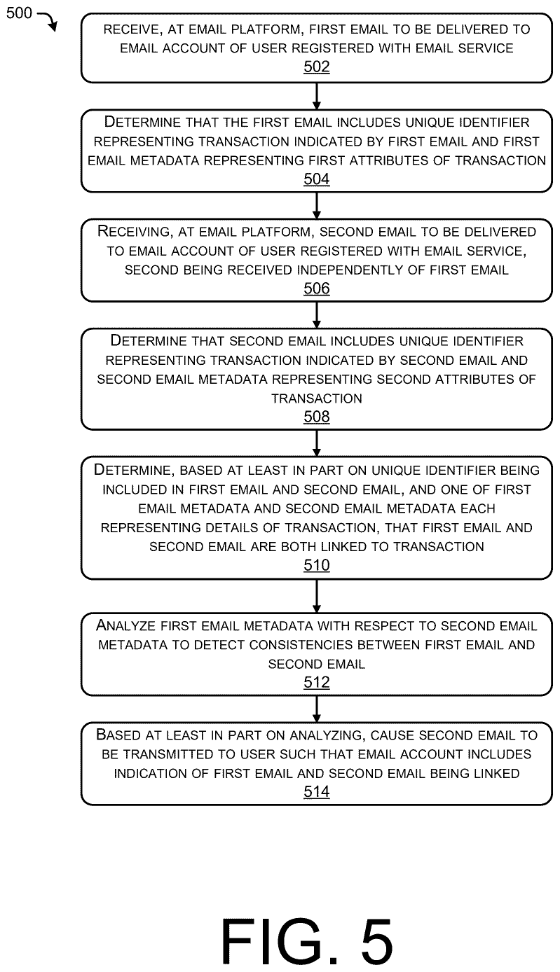

FIG. 5 illustrates a flow diagram of an example process 500 for linking emails related to the same transaction. The techniques may be applied by a system comprising one or more processors, and one or more non-transitory computer-readable media storing computer-executable instructions that, when executed by the one or more processors, cause the one or more processors to perform operations of process 500.

The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, although the processes may be implemented in a wide variety of other environments, architectures and systems.

At block 502, the process 500 may include receiving, at an email platform, a first email to be delivered to an email account of a user registered with an email service. For example, the email processing system may include a security system (e.g., a SEG) that may receive, or intercept, emails and/or other types of electronic communications that are to be communicated to users of the email service platform, such as being stored at a location that is accessible to the users via their respective inboxes.

At block 504, the process 500 may include determining that the first email includes a unique identifier representing a transaction indicated by the first email and first email metadata representing first attributes of the transaction. For example, an email received by the email processing system may include, or be associated with, a transaction. A transaction may be associated with e-commerce (e.g., a purchase of an item), financial transfers (e.g., transferring cash to a bank), services (e.g., purchasing an insurance policy) and/or other exchanges that may occur via an online platform. After receiving an email for a user (e.g., a receiving user) of the email service platform, the email processing system may be configured to extract recipient information associated with the email. For example, the email processing system may be configured to parse through a header of the email (e.g., “To-Field” addresses for the email).

In some instances, the email processing system may be configured to extract additional metadata (e.g., transactional metadata) associated with the content of an email, attachments associated with the email, links and/or URLs associated with the email, and/or the like. For example, transactional metadata may include one or more unique identifiers (e.g., order number, transaction identifier, reference number, etc.). Additionally, or alternatively, transactional metadata may include invoice and/or receipt details (e.g., time and date of the transaction, costs associated with the transaction, etc.), seller details (e.g., seller name, seller logo, etc.), shipper details (e.g., shipper name, shipper logo, etc.), product details (e.g., product, brand name, cost, etc.), transaction status (e.g., payment debited, payment received, etc.), and/or other data associated with the transaction of the email. In other words, the transactional metadata may include one or more attributes associated with the transaction of the email.

At block 506, the process 500 may include receiving, at the email platform, a second email to be delivered to the email account of the user registered with the email service, the second email being received independently of the first email. For example, the email processing system may include a security system (e.g., a SEG) that may receive, or intercept, emails and/or other types of electronic communications that are to be communicated to users of the email service platform, such as being stored at a location that is accessible to the users via their respective inboxes.

At block 508, the process 500 may include determining that the second email includes the unique identifier representing the transaction indicated by the second email and second email metadata representing second attributes of the transaction. For example, an email received by the email processing system may include, or be associated with, a transaction. A transaction may be associated with e-commerce (e.g., a purchase of an item), financial transfers (e.g., transferring cash to a bank), services (e.g., purchasing an insurance policy) and/or other exchanges that may occur via an online platform. After receiving an email for a user (e.g., a receiving user) of the email service platform, the email processing system may be configured to extract recipient information associated with the email. For example, the email processing system may be configured to parse through a header of the email (e.g., “To-Field” addresses for the email).

In some instances, the email processing system may be configured to extract additional metadata (e.g., transactional metadata) associated with the content of an email, attachments associated with the email, links and/or URLs associated with the email, and/or the like. For example, transactional metadata may include one or more unique identifiers (e.g., order number, transaction identifier, reference number, etc.). Additionally, or alternatively, transactional metadata may include invoice and/or receipt details (e.g., time and date of the transaction, costs associated with the transaction, etc.), seller details (e.g., seller name, seller logo, etc.), shipper details (e.g., shipper name, shipper logo, etc.), product details (e.g., product, brand name, cost, etc.), transaction status (e.g., payment debited, payment received, etc.), and/or other data associated with the transaction of the email. In other words, the transactional metadata may include one or more attributes associated with the transaction of the email.

At block 510, the process 500 may include determining, based at least in part on the unique identifier being included in the first email and the second email, and one the first email metadata and the second email metadata each representing details of the transaction, that the first email and the second email are both linked to the transaction. For example, based on a unique identifier of the email and/or transactional metadata, the email processing system may be configured to match, or link, the transaction of an incoming email to a previously-received email by the user of the email service (e.g., the recipient of the incoming email). Alternatively, and as described in more detail below, the email processing system may be configured to update a transaction database. In some instances, the email processing system may be configured to directly correlate an incoming email sent by an entity to a previously-received email sent by a different entity. For example, the email processing system may receive an incoming email indicating a transaction associated with a first entity. The email processing system may have previously received an email indicating a transaction associated with a second entity. The email processing system may determine that a unique identifier, such as an order number, of the incoming email sent by a first entity matches, or is consistent with, a unique identifier of the previously-received email sent by the second entity. Accordingly, the email processing system may correlate the transaction associated with the incoming email to the transaction of the previously-received email. In other words, the email processing system may determine that the incoming email sent by the first entity and the previously-received email sent by the second entity comprise, or are linked to, the same transaction.

Additionally, or alternatively, the email processing system may be configured to correlate the incoming email to the previously-received email based on transactional metadata (e.g., in the absence of a unique identifier, or in combination with a unique identifier). For example, the incoming email from the first entity may include an amount debited by the first entity, a date and time of the transaction, a brand name, and/or the like. The previously-received email sent by the second entity may include an amount received by the second entity that is consistent with the amount debited by the first entity. Additionally, or alternatively, the previously-received email may include an indication of the same (e.g., consistent) brand name and/or the data and time of the transaction. Accordingly, the email processing system may correlate the transaction associated with the incoming email to the transaction of the previously-received email.

At block 512, the process 500 may include analyzing the first email metadata with respect to the second email metadata to detect consistencies between the first email and the second email. For example, the email processing system may be configured to determine a confidence score associated with a correlation between transactions (e.g., the consistency between attributes of the transaction associated with the incoming email and the attributes of the transaction of the previously-received email). By way of example, and not limitation, a confidence score may indicate a confidence within a confidence range of 0-100. However, in other examples, the upper and/or lower bounds for the confidence range could be higher or lower, and/or the confidence range could be larger or smaller. As described above, the email processing system may be configured to directly correlate, correlate by reference, and/or correlate based on transactional metadata the incoming email to the previously-received email. For example, the email processing system may determine that the unique identifier of the incoming email matches the unique identifier of the previously-received email. Based on the unique identifiers matching, the email processing system may determine a confidence score of 70. Additionally, or alternatively, a confidence score may be increased (e.g., indicating a higher confidence) based on other matches, such as matching other data and/or transactional metadata. By way of example, and not limitation, the domain of the incoming email may match the domain of the previously-received email (e.g., both domains are e-commerce domains). Additionally, or alternatively, the intent of an incoming email may match the intent of the previously-received email (e.g., the intent of the previously-received email is payment and the intent of the incoming email is shipping). Additionally, or alternatively, the price of the transaction associated with the incoming email may match the price of the transaction associated with the previously-received email. Based on one or more additional matches (e.g., matches using metadata), the email processing system may increase the confidence score of 70 to a confidence score of 99.

The email processing system may be configured to determine if the confidence score meets or exceeds a threshold confidence score to link an incoming email to a previously-received incoming email. In instances where a confidence score for a match between an incoming email and a previously-received email meets or exceeds the threshold confidence score, the email processing system may be configured to link the incoming email and the previously-received email. By way of example, and not limitation, each email may be associated with a message identifier. For example, the previously-received email sent by a second entity may include a message identifier such as “MsgId1.” Additionally, or alternatively, the incoming email sent by a first entity may include a message identifier such as “MsgId2.” Using the message identifiers, the email processing system may determine reference data, where the reference data indicates a linkage between the incoming email and the previously-received email. For example, reference data may include an addition and/or modification to an “In-Reply-To” header of the incoming email and by the email processing system. The addition and/or modification to the “In-Reply-To” header may include an indication of the message identifier of the previously-received email (e.g., MsgId1). Additionally, or alternatively, the reference data may indicate linkage, or a reference, between the incoming email, the previously-received email, and/or other previously-received emails as part of an email “thread” (e.g., with a message identifier of MsgId3). For example, reference data may include an addition and/or modification to a “References” header of the incoming email and by the email processing system. The addition and/or modification to the “References” header may include an indication of the message identifier of the previously-received email and the email thread (e.g., MsgId1 and MsgId3).

At block 514, the process 500 may include, based at least in part on the analyzing, causing the second email to be transmitted to the user such that the email account includes an indication of the first email and second email being linked. For example, based on the reference data, the email processing system may be configured to forward and/or transmit an email to a receiving user such that the email is delivered to the receiving user's inbox. For example, the email processing system may forward and/or transmit the incoming email such that the incoming email is displayed as being consolidated (e.g., threaded to, or in conversation) with the previously-received email at the user's inbox. This way, emails received from different entities independently, but comprising at least a portion of the same transaction, may be displayed as if the emails were in reply to one another. Additionally, or alternatively, the email processing system may be configured to update a database of transactions and/or metadata to indicate the linkage (e.g., reference data) between an incoming email and one or more previously-received emails. The database may include one or more tables including linked emails, as well as other email attributes such as intent, domain, message identifier, unique identifier, transactional metadata, and/or references (e.g., linked emails).

In some examples, causing the second email to be transmitted to the user such that the email account includes the indication further comprises modifying a header of the first email to include a message identifier of the second email. In some examples, the first email metadata and/or the second email metadata may comprise at least one of a time associated with the transaction, an amount associated with the transaction, a product name associated with the transaction, a seller associated with the transaction, and/or a shipper associated with the transaction.

In some examples, the process 500 may include receiving, at the email platform, a third email to be delivered to the email account of the user, the third email being received independently of the first email, determining that the third email includes third email metadata representing third attributes of the transaction, and determining, based at least in part on the first email metadata and third email metadata each representing details of the transaction, that the third email metadata is linked to the transaction. The process 500 may further include analyzing the first email metadata with respect to the third email metadata to detect consistencies between the first email and the third email, and based at least in part on the analyzing, causing the third email to be transmitted to the user such that the email account includes an indication of the first email, the second email, and the third email being linked. In some examples, the process 500 may include determining, based on the first email and the second email both including the unique identifier, a first confidence score, determining that the first confidence score does not violate a threshold confidence, determining, based at least in part on the first email metadata and the second email metadata, a second confidence score, and determining that the second confidence score violates the threshold confidence, wherein the causing the second email to be transmitted to the user such that the email account includes the indication is based at least in part on the second confidence score.

In some examples, the first email is sent by a first entity and the second email is sent by a second entity, the second entity not being a recipient of the first email. Additionally, or alternatively, the process 500 may include receiving, at the email platform, a third email to be delivered to the email account of the user, the third email being received independently of the first email, determining that the third email includes third email metadata representing third attributes of the transaction, determining, based at least in part on the first email metadata and third email metadata each representing details of the transaction, that the third email metadata is linked to the transaction, and analyzing the first email metadata with respect to the third email metadata to detect consistencies between the first email and the third email. In some instances, the process 500 may include determining that the first email is inconsistent with the third email, determining, based on the first email being inconsistent with the third email, that the third email is an invalid email, and refraining from causing the invalid email to be transmitted to the user.

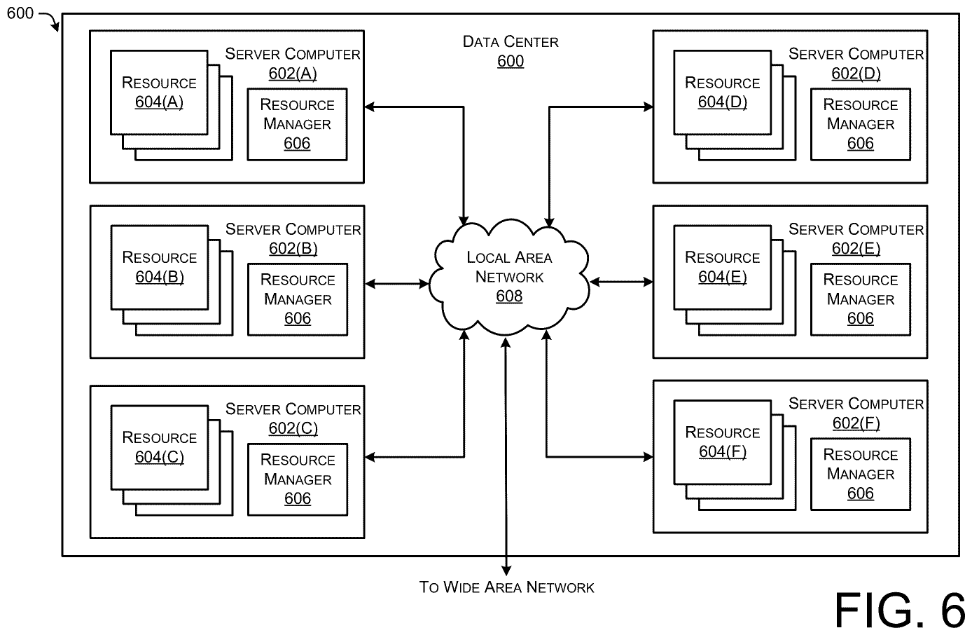

FIG. 6 is a computing system diagram illustrating a configuration for a data center 600 that can be utilized to implement aspects of the technologies disclosed herein. In one example, the data center 600 may be used to support the email processing system 104 and/or the service provider network 132. The example data center 600 shown in FIG. 6 includes several server computers 602A-602F (which might be referred to herein singularly as “a server computer 602” or in the plural as “the server computers 602”) for providing computing resources. In some examples, the resources and/or server computers 602 may include, or correspond to, the any type of networked device described herein. Although described as servers, the server computers 602 may comprise any type of networked device, such as servers, switches, routers, hubs, bridges, gateways, modems, repeaters, access points, etc.

The server computers 602 can be standard tower, rack-mount, or blade server computers configured appropriately for providing computing resources. In some examples, the server computers 602 may provide computing resources 604 including data processing resources such as VM instances or hardware computing systems, database clusters, computing clusters, storage clusters, data storage resources, database resources, networking resources, and others. Some of the server computers 602 can also be configured to execute a resource manager 606 capable of instantiating and/or managing the computing resources. In the case of VM instances, for example, the resource manager 606 can be a hypervisor or another type of program configured to enable the execution of multiple VM instances on a single server computer 602. Server computers 602 in the data center 600 can also be configured to provide network services and other types of services. In one example, server computers 602 may be used to support the email processing system 104 and/or the service provider network 132.

In the example data center 600 shown in FIG. 6, an appropriate LAN 608 is also utilized to interconnect the server computers 602A-602F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 600, between each of the server computers 602A-602F in each data center 600, and, potentially, between computing resources in each of the server computers 602. It should be appreciated that the configuration of the data center 600 described with reference to FIG. 6 is merely illustrative and that other implementations can be utilized.

In some examples, the server computers 602 may each execute one or more application containers and/or virtual machines to perform techniques described herein.

In some instances, the data center 600 may provide computing resources, like application containers, VM instances, and storage, on a permanent or an as-needed basis. Among other types of functionality, the computing resources provided by a cloud computing network may be utilized to implement the various services and techniques described above. The computing resources 604 provided by the cloud computing network can include various types of computing resources, such as data processing resources like application containers and VM instances, data storage resources, networking resources, data communication resources, network services, and the like.

Each type of computing resource 604 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 604 not mentioned specifically herein.

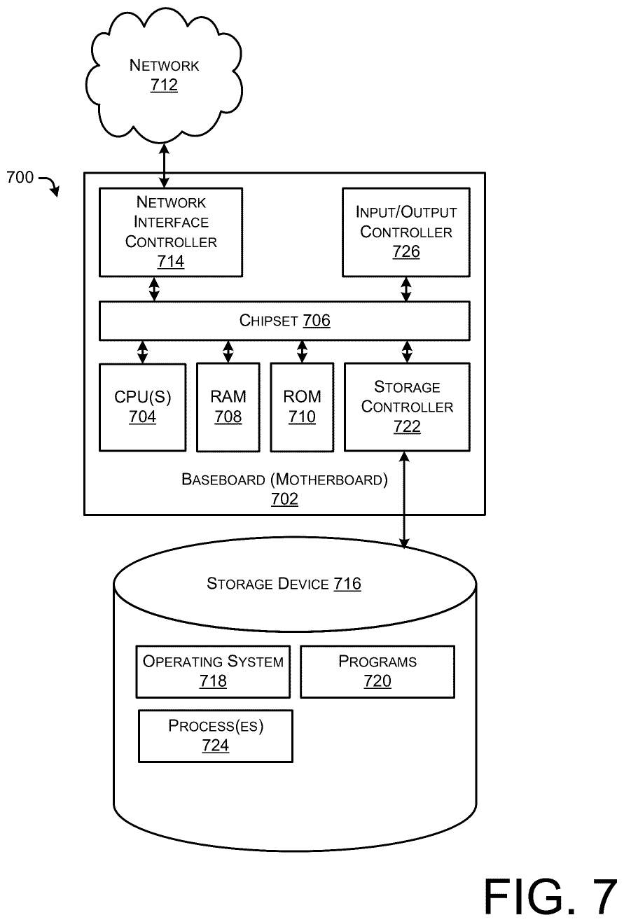

The computing resources 604 provided by a cloud computing network may be enabled in one embodiment by one or more data centers 600 (which might be referred to herein singularly as “a data center 600” or in the plural as “the data centers 600”). The data centers 600 are facilities utilized to house and operate computer systems and associated components. The data centers 600 typically include redundant and backup power, communications, cooling, and security systems. The data centers 600 can also be located in geographically disparate locations. One illustrative embodiment for a data center 600 that can be utilized to implement the technologies disclosed herein will be described below with regard to FIG. 7.

FIG. 7 shows an example computer architecture for a computer 700 capable of executing program components for implementing the functionality described above. The computer architecture shown in FIG. 7 illustrates a conventional server computer, workstation, desktop computer, laptop, tablet, network appliance, e-reader, smartphone, or other computing device, and can be utilized to execute any of the software components presented herein. The computer 700 may, in some examples, correspond to a network node described herein.

The computer 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a random-access memory (RAM) 708, used as the main memory in the computer 700. The chipset 706 can further provide an interface to a computer-readable storage medium such as a read-only memory (ROM) 710 or non-volatile RAM (NVRAM) for storing basic routines that help to startup the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network, such as the network 712. The chipset 706 can include functionality for providing network connectivity through a network interface controller (NIC) 714, such as a gigabit Ethernet adapter. The NIC 714 is capable of connecting the computer 700 to other computing devices over the network 712. It should be appreciated that multiple NICs 714 can be present in the computer 700, connecting the computer 700 to other types of networks and remote computer systems. In some instances, the NICs 714 may include at least on ingress port and/or at least one egress port.

The computer 700 can be connected to a storage device 716 that provides non-volatile storage for the computer. The storage device 716 can store an operating system 718, programs 720, and data, which have been described in greater detail herein. The storage device 716 can be connected to the computer 700 through a storage controller 722 connected to the chipset 706. The storage device 716 can consist of one or more physical storage units. The storage controller 722 can interface with the physical storage units through a serial attached small computer system interface (SCSI) (SAS) interface, a serial advanced technology attachment (SATA) interface, a fiber channel (FC) interface, or other type of interface for physically connecting and transferring data between computers and physical storage units.

The computer 700 can store data on the storage device 716 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 716 is characterized as primary or secondary storage, and the like.

For example, the computer 700 can store information to the storage device 716 by issuing instructions through the storage controller 722 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 can further read information from the storage device 716 by detecting the physical states or characteristics of one or more particular locations within the physical storage units.

In addition to the mass storage device 716 described above, the computer 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 700. In some examples, the operations performed by any network node described herein may be supported by one or more devices similar to computer 700. Stated otherwise, some or all of the operations performed by a network node may be performed by one or more computers 700 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 716 can store an operating system 718 utilized to control the operation of the computer 700. According to one embodiment, the operating system comprises the LINUX™ operating system. According to another embodiment, the operating system includes the WINDOWS™ SERVER operating system from MICROSOFT Corporation of Redmond, Washington. According to further embodiments, the operating system can comprise the UNIX™ operating system or one of its variants. It should be appreciated that other operating systems can also be utilized. The storage device 716 can store other system or application programs and data utilized by the computer 700.

In one embodiment, the storage device 716 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes described above with regard to FIGS. 1-6. The computer 700 can also include computer-readable storage media having instructions stored thereupon for performing any of the other computer-implemented operations described herein.

As illustrated in FIG. 7, the storage device 716 stores programs 720, which may include one or more processes 724. The process(es) 724 may include instructions that, when executed by the CPU(s) 704, cause the computer 700 and/or the CPU(s) 704 to perform one or more operations.

The computer 700 can also include at least one input/output controller 726 for receiving and processing input from a number of input devices, such as a keyboard, a mouse, a touchpad, a touch screen, an electronic stylus, or other type of input device. Similarly, an input/output controller 726 can provide output to a display, such as a computer monitor, a flat-panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.” As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A method comprising:
receiving, at an email platform, a first email to be delivered to an email account of a user registered with an email service;
determining that the first email includes a unique identifier representing a transaction indicated by the first email and first email metadata representing first attributes of the transaction;
receiving, at the email platform, a second email to be delivered to the email account of the user registered with the email service, the second email being received independently of the first email;
determining that the second email includes the unique identifier representing the transaction indicated by the second email and second email metadata representing second attributes of the transaction;
determining, based at least in part on the unique identifier being included in the first email and the second email, and one the first email metadata and the second email metadata each representing details of the transaction, that the first email and the second email are both linked to the transaction;
analyzing the first email metadata with respect to the second email metadata to detect consistencies between the first email and the second email; and
based at least in part on the analyzing, causing the second email to be transmitted to the user such that the email account includes an indication of the first email and second email being linked.

2. The method of claim 1, wherein causing the second email to be transmitted to the user such that the email account includes the indication further comprises modifying a header of the first email to include a message identifier of the second email.

3. The method of claim 1, wherein at least one of the first email metadata or the second email metadata comprises at least one of:
a time associated with the transaction;
an amount associated with the transaction;
a product name associated with the transaction;
a seller associated with the transaction; or
a shipper associated with the transaction.

4. The method of claim 1, further comprising:
receiving, at the email platform, a third email to be delivered to the email account of the user, the third email being received independently of the first email;
determining that the third email includes third email metadata representing third attributes of the transaction;
determining, based at least in part on the first email metadata and third email metadata each representing details of the transaction, that the third email metadata is linked to the transaction;
analyzing the first email metadata with respect to the third email metadata to detect consistencies between the first email and the third email; and
based at least in part on the analyzing, causing the third email to be transmitted to the user such that the email account includes an indication of the first email, the second email, and the third email being linked.

5. The method of claim 1, further comprising:
determining, based on the first email and the second email both including the unique identifier, a first confidence score;
determining that the first confidence score does not violate a threshold confidence;
determining, based at least in part on the first email metadata and the second email metadata, a second confidence score; and
determining that the second confidence score violates the threshold confidence,
wherein the causing the second email to be transmitted to the user such that the email account includes the indication is based at least in part on the second confidence score.

6. The method of claim 1, wherein the first email is sent by a first entity and the second email is sent by a second entity, the second entity not being a recipient of the first email.

7. The method of claim 1, further comprising:
receiving, at the email platform, a third email to be delivered to the email account of the user, the third email being received independently of the first email;
determining that the third email includes third email metadata representing third attributes of the transaction;
determining, based at least in part on the first email metadata and third email metadata each representing details of the transaction, that the third email metadata is linked to the transaction;
analyzing the first email metadata with respect to the third email metadata to detect consistencies between the first email and the third email;
determining that the first email is inconsistent with the third email;
determining, based on the first email being inconsistent with the third email, that the third email is an invalid email; and
refraining from causing the invalid email to be transmitted to the user.

8. A system comprising:
one or more processors; and
one or more non-transitory computer-readable media storing computer-executable instructions that, when executed by the one or more processors, cause the one or more processors to perform operations comprising:
receiving, at an email platform, a first email to be delivered to an email account of a user registered with an email service;
determining that the first email includes a unique identifier representing a transaction indicated by the first email and first email metadata representing first attributes of the transaction;
receiving, at the email platform, a second email to be delivered to the email account of the user registered with the email service, the second email being received independently of the first email;
determining that the second email includes the unique identifier representing the transaction indicated by the second email and second email metadata representing second attributes of the transaction;
determining, based at least in part on the unique identifier being included in the first email and the second email, and one the first email metadata and second email metadata each representing details of the transaction, that the first email and the second email are both linked to the transaction;
analyzing the first email metadata with respect to the second email metadata to detect consistencies between the first email and the second email; and
based at least in part on the analyzing, causing the second email to be transmitted to the user such that the email account includes an indication of the first email and the second email being linked.

9. The system of claim 8, wherein causing the second email to be transmitted to the user such that the email account includes the indication further comprises modifying a header of the first email to include a message identifier of the second email.

10. The system of claim 8, wherein at least one of the first email metadata or the second email metadata comprises at least one of:
a time associated with the transaction;
an amount associated with the transaction;
a product name associated with the transaction;
a seller associated with the transaction; or
a shipper associated with the transaction.

11. The system of claim 8, the operations further comprising:
receiving, at the email platform, a third email to be delivered to the email account of the user, the third email being received independently of the first email;
determining that the third email includes third email metadata representing third attributes of the transaction;
determining, based at least in part on the first email metadata and third email metadata each representing details of the transaction, that the third email metadata is linked to the transaction;
analyzing the first email metadata with respect to the third email metadata to detect consistencies between the first email and the third email; and
based at least in part on the analyzing, causing the third email to be transmitted to the user such that the email account includes an indication of the first email, the second email, and the third email being linked.

12. The system of claim 8, the operations further comprising:
determining, based on the first email and the second email both including the unique identifier, a first confidence score;
determining that the first confidence score does not violate a threshold confidence;
determining, based at least in part on the first email metadata and the second email metadata, a second confidence score; and
determining that the second confidence score violates the threshold confidence,
wherein the causing the second email to be transmitted to the user such that the email account includes the indication is based at least in part on the second confidence score.

13. The system of claim 8, wherein the first email is sent by a first entity and the second email is sent by a second entity, the second entity not being a recipient of the first email.

14. The system of claim 8, the operations further comprising:
receiving, at the email platform, a third email to be delivered to the email account of the user, the third email being received independently of the first email;
determining that the third email includes third email metadata representing third attributes of the transaction;
determining, based at least in part on the first email metadata and third email metadata each representing details of the transaction, that the third email metadata is linked to the transaction;
analyzing the first email metadata with respect to the third email metadata to detect consistencies between the first email and the third email;
determining that the first email is inconsistent with the third email;
determining, based on the first email being inconsistent with the third email, that the third email is an invalid email; and
refraining from causing the invalid email to be transmitted to the user.

15. One or more non-transitory computer-readable media storing computer-executable instructions that, when executed by one or more processors, cause the one or more processors to perform operations comprising:
receiving, at an email platform, a first email to be delivered to an email account of a user registered with an email service;
determining that the first email includes a unique identifier representing a transaction indicated by the first email and first email metadata representing first attributes of the transaction;
receiving, at the email platform, a second email to be delivered to the email account of the user registered with the email service, the second email being received independently of the first email;
determining that the second email includes the unique identifier representing the transaction indicated by the second email and second email metadata representing second attributes of the transaction;
determining, based at least in part on the unique identifier being included in the first email and the second email, and one the first email metadata and second email metadata each representing details of the transaction, that the first email and the second email are both linked to the transaction;
analyzing the first email metadata with respect to the second email metadata to detect consistencies between the first email and the second email; and
based at least in part on the analyzing, causing the second email to be transmitted to the user such that the email account includes an indication of the first email and the second email being linked.

16. The one or more non-transitory computer-readable media of claim 15, wherein at least one of the first email metadata or the second email metadata comprises at least one of:
a time associated with the transaction;
an amount associated with the transaction;
a product name associated with the transaction;
a seller associated with the transaction; or
a shipper associated with the transaction.

17. The one or more non-transitory computer-readable media of claim 15, the operations further comprising:
receiving, at the email platform, a third email to be delivered to the email account of the user, the third email being received independently of the first email;
determining that the third email includes third email metadata representing third attributes of the transaction;
determining, based at least in part on the first email metadata and third email metadata each representing details of the transaction, that the third email metadata is linked to the transaction;
analyzing the first email metadata with respect to the third email metadata to detect consistencies between the first email and the third email; and
based at least in part on the analyzing, causing the third email to be transmitted to the user such that the email account includes an indication of the first email, the second email, and the third email being linked.

18. The one or more non-transitory computer-readable media of claim 15, the operations further comprising:
determining, based on the first email and the second email both including the unique identifier, a first confidence score;
determining that the first confidence score does not violate a threshold confidence;
determining, based at least in part on the first email metadata and the second email metadata, a second confidence score; and
determining that the second confidence score violates the threshold confidence,
wherein the causing the second email to be transmitted to the user such that the email account includes the indication is based at least in part on the second confidence score.

19. The one or more non-transitory computer-readable media of claim 15, wherein the first email is sent by a first entity and the second email is sent by a second entity, the second entity not being a recipient of the first email.

20. The one or more non-transitory computer-readable media of claim 15, the operations further comprising:
receiving, at the email platform, a third email to be delivered to the email account of the user, the third email being received independently of the first email;
determining that the third email includes third email metadata representing third attributes of the transaction;
determining, based at least in part on the first email metadata and third email metadata each representing details of the transaction, that the third email metadata is linked to the transaction;
analyzing the first email metadata with respect to the third email metadata to detect consistencies between the first email and the third email;
determining that the first email is inconsistent with the third email;
determining, based on the first email being inconsistent with the third email, that the third email is an invalid email; and
refraining from causing the invalid email to be transmitted to the user.
